(19) United States
(12) Patent Application Publication
(10) Pub. No.: US 2025/0104673 A1
(43) Pub. Date: Mar. 27, 2025

(54) SONG SHEET SPECIFICATION, FORMATTING, AND GENERATION SYSTEM AND METHOD

(71) Applicant: Jean David Margulici, Oakland, CA (US)

(72) Inventor: Jean David Margulici, Oakland, CA (US)

(21) Appl. No.: 18/890,533

(22) Filed: Sep. 19, 2024

Related U.S. Application Data
(60) Provisional application No. 63/585,030, filed on Sep. 25, 2023.

(51) Int. Cl. G10G 1/02; G06F 40/103; G06F 40/205

(52) U.S. Cl. CPC G10G 1/02; G06F 40/103; G06F 40/205

(57) ABSTRACT

A system and method generate a data structure comprising a song map. The system receives a song specification comprising metadata, chord sequences, song sections, and lyrics. The specification is parsed to identify these elements, which are then mapped to corresponding sections. A song map is generated, and a graphical user interface may display information associated with the song map to display the song sections, chord sequences, and lyrics and highlight a particular song section, chord sequence, and lyrics in realtime during playback of the particular song. The system includes a user interface, a parser, a mapping module, and a rendering module. The system performs these functions and can export the output in various formats, including PDF, HTML, and SVG.

### CROSS-REFERENCE TO RELATED APPLICATIONS

This application claims the benefit of U.S. Provisional Application No. 63/585,030 filed Sep. 25, 2023, entitled “Method and System for Song Shect Specification, Formatting and Publication,” the entire contents of which are incorporated herein by reference.

### BACKGROUND

Existing methods for notating and presenting songs as sheet music include full scores, lead sheets, and the ChordPro format.

Full Scores provide detailed notation of rhythm and pitch for different voices or instruments, offering a comprehensive and precise transcription of the entire song. One obvious limitation of full scores is that they require musicians to read standard music notation, whereas many popular music practitioners have no or limited reading skills. Another limitation of full scores is that they often extend over multiple pages, making them cumbersome for musicians to use during live performances. The need to turn pages while playing can disrupt the performance, and the large size limits portability and case of use, particularly in outdoor or crowded settings.

Lead Sheets condense the notation to the most critical musical elements, such as the melody and primary harmonies. Lead sheets are more compact than full scores, but generally still suffer from the same limitations: they can only be read by skilled practitioners, and they still typically extend over multiple pages. Additionally, lead sheets are not well suited to notating multiple voices. If they do then they essentially become full scores.

The ChordPro Format simplifies the notation further by focusing primarily on chords and lyrics. However, it lacks rhythm notation, which is crucial for synchronized performance in a band setting. This format requires double-spacing in order to insert chord names above lyrics, and hence it also often spans multiple pages per song. The ChordPro format does not provide a clear visual structure of the song's sections, making it a less effective medium of communication between musicians.

These limitations demonstrate the need for a new format that combines the advantages of these existing methods while addressing their shortcomings, particularly in terms of portability, case of use, and clarity for band performances.

It is with these issues in mind, among others, that various aspects of the disclosure were conceived.

### SUMMARY

The disclosure relates to a system and method for song sheet specification, formatting, and generation, particularly suited for popular music and band performances. Traditional song sheet formats, such as full scores, lead sheets, and ChordPro, have limitations in terms of portability, legibility, and usability during live performances. The system and method overcomes these limitations by generating a compact, user-friendly song sheet based on a song map data structure that may be displayed by a graphical user interface that improves on memory usage by efficiently storing information and efficiently capturing the essential elements of a song.

The system and method includes receiving a song specification that includes metadata, chord sequences, song sections, and lyrics. The specification is parsed to identify and categorize these elements, which are then mapped to their corresponding sections to create a “song map.” The song map is used to generate a digital document to be displayed by a graphical user interface (GUI) that displays the mapped elements in a format optimized for case of use and readability.

The system comprises several modules: a user interface for receiving inputs in multiple formats, a parser to process the input, a mapping module to associate song sections with chord sequences and lyrics, and a rendering module to generate the formatted digital document. The system may include a software application to execute these modules through executable code, supporting various output formats such as PDF, HTML, and SVG.

By addressing the need for a more practical and effective song sheet format, the system significantly improves the experience of songwriters and musicians, particularly those performing in bands. The system offers enhanced portability, legibility, and customization options, allowing for a more pleasant and efficient performance environment.

In one example, a method may include receiving, by at least one processor, a song specification that represents a particular song in a structured text format, the song specification comprising metadata, chord sequences, song sections, and lyrics, the structured text format comprising one of a text file, extensible markup language (XML), and Javascript Object Notation (JSON), parsing, by the at least one processor, the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, mapping, by the at least one processor, each song section to corresponding chord sequences and lyrics by generating a data structure comprising a song map, generating, by the at least one processor, a graphical user interface (GUI) representation of the song map to display the song sections, chord sequences, and lyrics and highlighting a particular song section, chord sequence, and lyrics in realtime during playback of the particular song, and storing, by the at least one processor, the song map in an output format comprising one of a Portable Document Format (PDF), Hypertext Markup Language (HTML), and Scalable Vector Graphics (SVG).

In another example, a system may include a non-transitory computer-readable storage medium having instructions and at least one processor to execute the instructions to receive a song specification that represents a particular song in a structured text format, the song specification comprising metadata, chord sequences, song sections, and lyrics, the structured text format comprising one of a text file, extensible markup language (XML), and Javascript Object Notation (JSON), parse the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, map each song section to corresponding chord sequences and lyrics by generating a data structure comprising a song map, generate a graphical user interface (GUI) representation of the song map to display the song sections, chord sequences, and lyrics and highlight a particular song section, chord sequence, and lyrics in realtime during playback of the particular song, and store the song map in an output format comprising one of a Portable Document Format (PDF), Hypertext Markup Language (HTML), and Scalable Vector Graphics (SVG).

In another example, a non-transitory computer-readable storage medium may have instructions stored thereon that, when executed by at least one computing device cause the at least one computing device to perform operations, the operations including receiving a song specification that represents a particular song in a structured text format, the song specification comprising metadata, chord sequences, song sections, and lyrics, the structured text format comprising one of a text file, extensible markup language (XML), and Javascript Object Notation (JSON), parsing the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, mapping each song section to corresponding chord sequences and lyrics by generating a data structure comprising a song map, generating a graphical user interface (GUI) representation of the song map to display the song sections, chord sequences, and lyrics and highlighting a particular song section, chord sequence, and lyrics in realtime during playback of the particular song, and storing the song map in an output format comprising one of a Portable Document Format (PDF), Hypertext Markup Language (HTML), and Scalable Vector Graphics (SVG).

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a photograph of sheet music that displays long-form music staffs, typical of full scores, or lead sheets according to an example of the instant disclosure.

FIG. 2 is a photograph of ChordPro song sheets, which display double-spaced lyrics with chord names above words and may include guitar chord charts according to an example of the instant disclosure.

FIG. 3 is a photograph of song sheets created using the system, showing labeled chord grids, song sections, and mapping between song sections and chord progressions according to an example of the instant disclosure.

FIG. 4 exhibits a complete song sheet created by a song sheet specification formatting, and generation system, highlighting elements, including the header, chord sequences, and song sections according to an example of the instant disclosure.

FIG. 5 is a schematic diagram illustrating the relationships between song lyrics, song sections, and chord grids according to an example of the instant disclosure.

FIG. 6 represents the building blocks of a song sheet created using the system, showing the breakdown into song metadata, chord sequences, and song sections and lyrics according to an example of the instant disclosure.

FIG. 7 shows how the chord sequences and song sections are represented and related to each other within a song sheet according to an example of the instant disclosure.

FIG. 8 is a flowchart that shows functions of the system, from input to output according to an example of the instant disclosure.

FIG. 9 provides an illustrated example of a song specification using the method demonstrating the metadata, chord sequences, and song sections according to an example of the instant disclosure.

FIG. 10 is a block diagram of the song sheet specification, formatting, and generation system according to an example of the instant disclosure.

FIG. 11 is a flowchart of a method for generating a song map by the song sheet specification, formatting, and generation system according to an example of the instant disclosure.

FIG. 12 shows an example of a system for implementing certain aspects of the present technology.

### DETAILED DESCRIPTION

The present invention is more fully described below with reference to the accompanying figures. The following description is exemplary in that several embodiments are described (e.g., by use of the terms “preferably,” “for example,” or “in one embodiment”); however, such should not be viewed as limiting or as setting forth the only embodiments of the present invention, as the invention encompasses other embodiments not specifically recited in this description, including alternatives, modifications, and equivalents within the spirit and scope of the invention. Further, the use of the terms “invention,” “present invention,” “embodiment,” and similar terms throughout the description are used broadly and not intended to mean that the invention requires, or is limited to, any particular aspect being described or that such description is the only manner in which the invention may be made or used. Additionally, the invention may be described in the context of specific applications; however, the invention may be used in a variety of applications not specifically described.

The embodiment(s) described, and references in the specification to “one embodiment”, “an embodiment”, “an example embodiment”, etc., indicate that the embodiment(s) described may include a particular feature, structure, or characteristic. Such phrases are not necessarily referring to the same embodiment. When a particular feature, structure, or characteristic is described in connection with an embodiment, persons skilled in the art may effect such feature, structure, or characteristic in connection with other embodiments whether or not explicitly described.

In the several figures, like reference numerals may be used for like elements having like functions even in different drawings. The embodiments described, and their detailed construction and elements, are merely provided to assist in a comprehensive understanding of the invention. Thus, it is apparent that the present invention can be carried out in a variety of ways, and does not require any of the specific features described herein. Also, well-known functions or constructions are not described in detail since they would obscure the invention with unnecessary detail. Any signal arrows in the drawings/figures should be considered only as exemplary, and not limiting, unless otherwise specifically noted. Further, the description is not to be taken in a limiting sense, but is made merely for the purpose of illustrating the general principles of the invention, since the scope of the invention is best defined by the appended claims.

It will be understood that, although the terms “first,” “second,” etc. may be used herein to describe various elements, these elements should not be limited by these terms. These terms are only used to distinguish one element from another. Purely as a non-limiting example, a first element could be termed a second element, and, similarly, a second element could be termed a first element, without departing from the scope of example embodiments. As used herein, the term “and/or” includes any and all combinations of one or more of the associated listed items. As used herein, the singular forms “a”, “an,” and “the” are intended to include the plural forms as well, unless the context clearly indicates otherwise. It should also be noted that, in some alternative implementations, the functions and/or acts noted may occur out of the order as represented in at least one of the several figures. Purely as a non-limiting example, two figures shown in succession may in fact be executed substantially concurrently or may sometimes be executed in the reverse order, depending upon the functionality and/or acts described or depicted.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Aspects of a system and method for song sheet specification, formatting, and generation includes receiving, by at least one processor, a song specification that represents a particular song in a structured text format, the song specification comprising metadata, chord sequences, song sections, and lyrics, the structured text format comprising one of a text file, extensible markup language (XML), and Javascript Object Notation (JSON), parsing, by the at least one processor, the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, mapping, by the at least one processor, each song section to corresponding chord sequences and lyrics by generating a data structure comprising a song map, generating, by the at least one processor, a graphical user interface (GUI) representation of the song map to display the song sections, chord sequences, and lyrics and highlighting a particular song section, chord sequence, and lyrics in realtime during playback of the particular song, and storing, by the at least one processor, the song map in an output format comprising one of a Portable Document Format (PDF), Hypertext Markup Language (HTML), and Scalable Vector Graphics (SVG).

The system and method relate to the notation and presentation of songs as sheet music. More specifically, the system and method may describe and assemble semantic components of a song, representing these components in a compact and legible manner, and automatically produce formatted song sheets as digital documents.

The disclosure relates to a system and method for the specification, formatting, and generation of song sheets, particularly for popular music, in a compact and legible format optimized for band performances. The system and method address the limitations of existing song sheet formats, such as full scores, lead sheets, and ChordPro, by introducing a structured way to notate and display song information on a graphical user interface (GUI) in realtime that enhances usability, portability, and performance quality for musicians.

The method for generating a formatted song sheet may include receiving a song specification that includes metadata, chord sequences, song sections, and lyrics. The song specification is parsed to identify and categorize these components. The method maps song sections to corresponding chord sequences and lyrics, and then generates a graphical user interface (GUI) that displays the mapped song sections, chord sequences, and lyrics in a compact and legible format, suitable for band performances. In addition, a system may implement this method, allowing for the automatic generation of song sheets in various formats.

### Components and Operation of the System

### 1. Song Specification Format

The song specification may be a structured text input that includes the following elements:

Metadata: Contains key information about the song, such as the title, composer, tempo, key signature, time signature, and other relevant attributes such as tags and categories that help query and filter songs that are part of a collection.

Chord Sequences: A set of labeled chord grids, where each grid represents a measure of music. The grids may be subdivided into smaller units (e.g., half-measures) to indicate chord changes.

Song Sections: Labeled sections such as “Intro,” “Verse 1,” “Chorus,” “Bridge,” and “Outro,” which define the structure of the song. Each section is associated with specific chord sequences and lyrics.

Lyrics: Text representing the lyrics of the song, mapped to specific song sections.

### 2. Method for Generating Formatted Song Sheets

The method includes the following:

### Receiving the Song Specification

A song specification may be received in a structured text format, including metadata, chord sequences, song sections, and lyrics. The specification may be inputted by a user through an interface or imported from a text file, XML, JSON, or other formats.

### Parsing the Song Specification

The song specification is parsed to identify and categorize the metadata, chord sequences, song sections, and lyrics. This parsing step uses pattern recognition techniques, such as regular expressions, to detect specific elements based on their labels and content.

### Mapping Song Sections to Chord Sequences and Lyrics

The parsed song sections are mapped to their corresponding chord sequences and lyrics. For example, a “Chorus 1” section may be mapped to a predefined chord grid labeled “Chorus” and a specific paragraph of lyrics. The mapping involves creating a data structure, referred to as a “song map,” that maintains these relationships.

### Generating the Graphical User Interface

The song map is then used to generate a graphical user interface and output that may visually display the mapped song sections, chord sequences, and lyrics in realtime. The user interface is formatted to be compact and legible, with options for single-page display, interactive elements, or custom layouts. The document can be output in various formats, such as PDF, HTML, or SVG.

### 3. System for Generating Formatted Song Sheets

The system may include the following modules:

User Interface Module: Allows users to input song specifications in multiple formats, including plain text, XML, and JSON. The user interface module may provide options for customization, such as layout, font size, and color.

Parser Module: Processes the song specification to identify and categorize metadata, chord sequences, song sections, and lyrics.

Mapping Module: Maintains a set of specified chord sequences and maps song sections to their corresponding chord sequences and lyrics.

Rendering Module: Generates the graphical user interface in a format optimized for band performances. The rendering module may support various output formats and could include an interactive feature for song playback.

### 4. Method for Generating Formatted Song Sheets

The method may perform the following functions:

Receiving and Parsing Input: Accepts song specifications from a user or external source, parses the input using regular expressions or other pattern recognition methods, and stores the parsed data in a structured format.

Mapping Song Elements: Establishes relationships between song sections, chord sequences, and lyrics based on predefined rules or user input.

Generating the Output: Produces a formatted graphical user interface and output that displays the mapped elements. The output can be previewed by the user and exported in various digital formats, including PDF, HTML, or SVG. The software may also include an application programming interface (API) for integration with third-party applications.

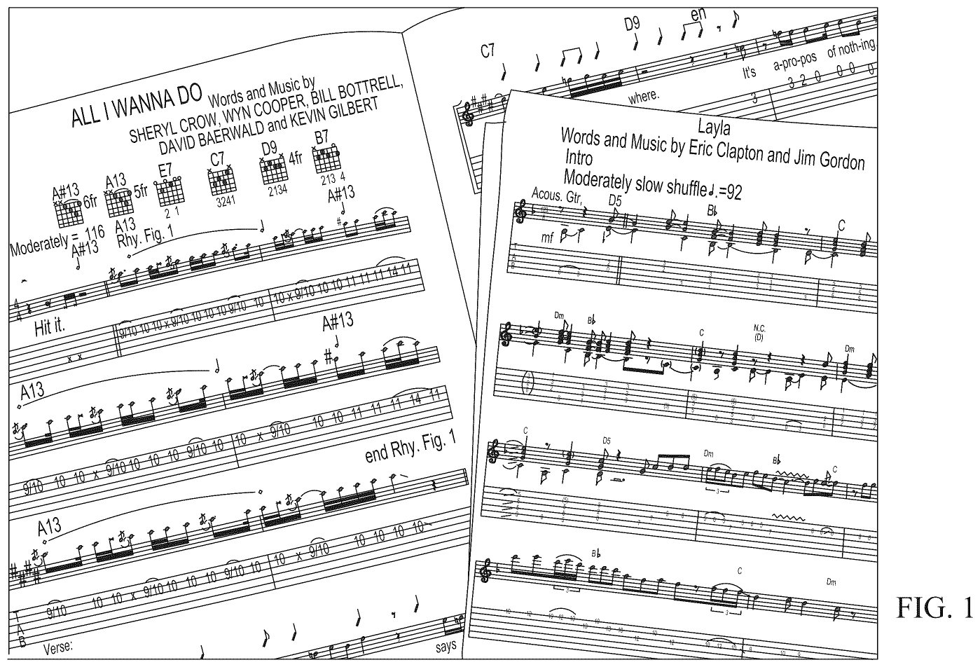

FIG. 1 illustrates a conventional song sheet using long-form music staffs, typical of full scores or lead sheets, which extends over multiple pages according to an example of the instant disclosure.

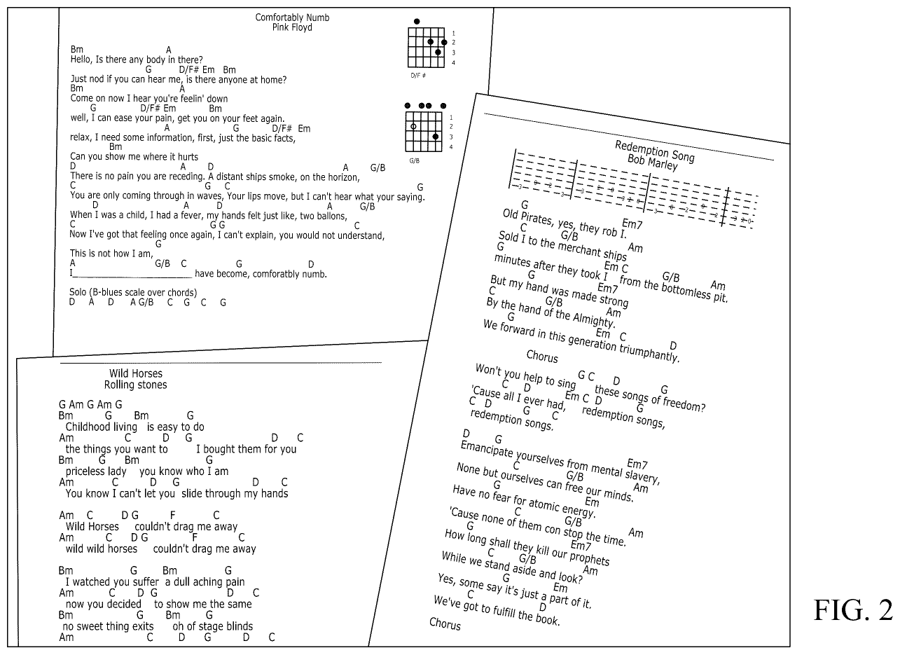

FIG. 2 depicts a song sheet formatted in the ChordPro style, showing double-spaced lyrics with chord names inserted above the words according to an example of the instant disclosure.

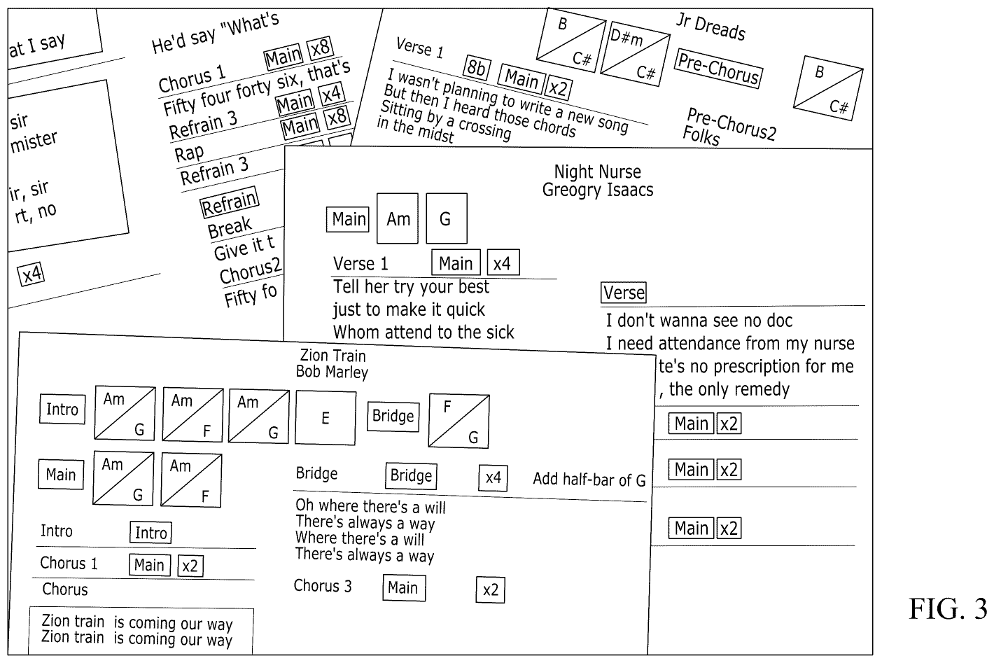

FIG. 3 shows a song sheet created by the system, featuring labeled chord grids, song sections, and the mapping between sections and chord progressions according to an example of the instant disclosure.

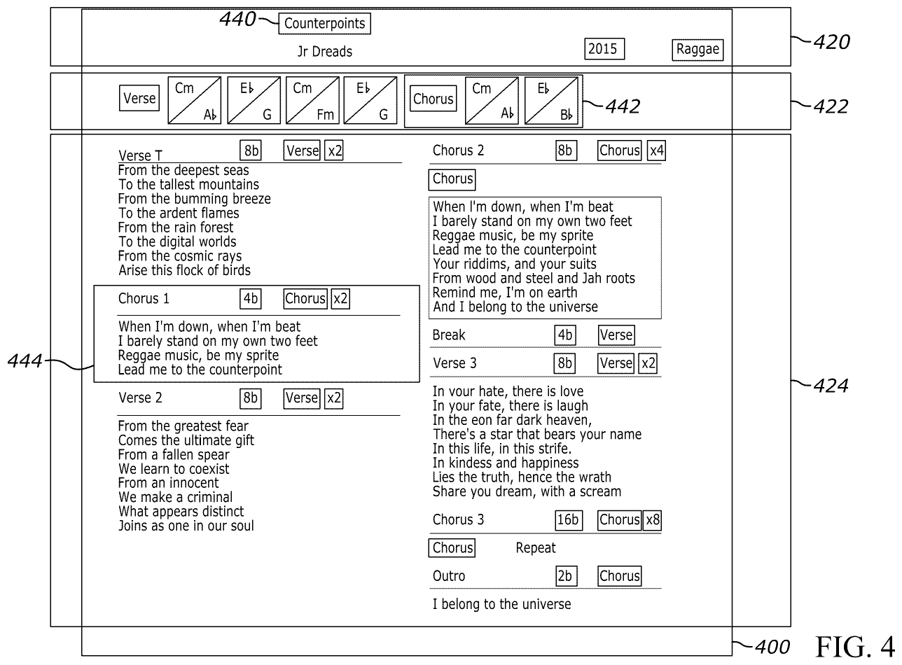

FIG. 4 shows a song sheet 400 created by the system according to an example of the instant disclosure. Notably, the sheet comprises a header section 420, a set of labeled chord sequences 422, and a body 424 that displays labeled song sections, along with their respective musical and lyrical content.

More specifically, FIG. 4 highlights song metadata displayed in the header section, such as the song title 440. A chord sequence as a grid and its label is marked 442. In this example, the chord sequence is labeled “Chorus” and shows two green squares, hence the “grid” terminology. Each square may represent a measure of music. In the particular example 442, each measure is further divided into two half-measures over which the following chords are played in sequence: C minor, A flat major, E flat, and B flat. Finally, a song section 444 is highlighted as well. It shows the label “Chorus 1”, followed by the duration of the section “4b”, which stands for four “bars,” or equivalently four measures, and the chord progression, which repeats the Chorus chord sequence twice. Below the section's label is a paragraph of lyrics for that particular section of the song.

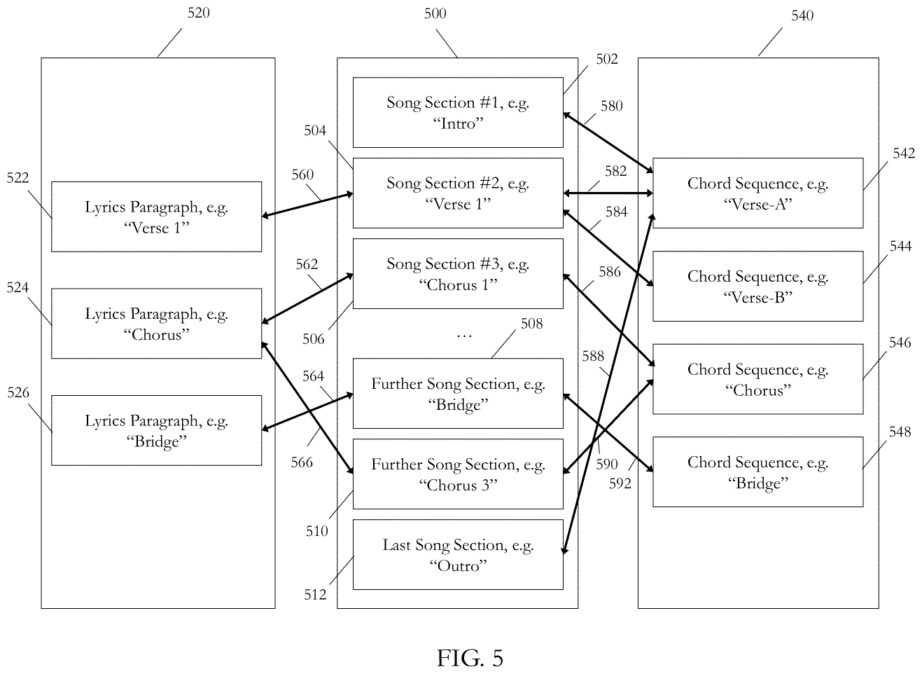

FIG. 5 describes the essential relationship between the components of a song, from left to right including lyrics 520, song sections 500, and chord sequences 540 according to an example of the instant disclosure. For the purpose of illustration, three blocks of lyrics 522, 524 and 526 are labeled “Verse 1”, “Chorus” and “Bridge”, respectively. Likewise, six song sections 502, 504, 506, 508, 510 and 512 are represented, with possibly more sections voluntarily omitted for brevity, as indicated by the separating ellipsis between 506 and 508. Finally, and still as an illustrative example, four chord sequences 542, 544, 546, 548 comprise the song's musical content. The salient point for FIG. 5 is the mapping relationships between sections and lyrics on the one hand, represented by arrows 560, 562 and 564, and between sections and chords, represented by arrows 580, 582, 584, 586, 588, 590 and 592. The method may hinge on explicit specification and representation of these mappings. More specifically, the method recognizes that there exists a many-to-many sequential relationship between song sections and lyrics, as well as a many-to-many sequential relationship between song sections and chord sequences. A many-to-many sequential relationship means that the lyrics to a given song section may include one or more paragraphs of lyrics assembled in a specific sequence, which may include repetitions of some of these paragraphs; and that, conversely, a given paragraph of lyrics may be referenced by one or more song sections. Likewise, the chord progression for a given song section may include one or more chord sequences played in a specific arrangement, including possible repetitions, and conversely, a chord sequence may be referenced by one or multiple song sections. For instance, the illustrative example in FIG. 5 shows that both song sections “Chorus 1” 506 and “Chorus 3” 510 may include the same lyrics “Chorus” 524. Likewise, these two song sections share the same chord progression, which is based on one or more repetitions (FIG. 5 does not show the number of repetitions, but this aspect of the method is described further herein) of the “Chorus” chord sequence 546. Further, the chord progression for song section “Verse 1” 504 is comprised of chord sequences “Verse-A” 542 and “Verse-B” 544.

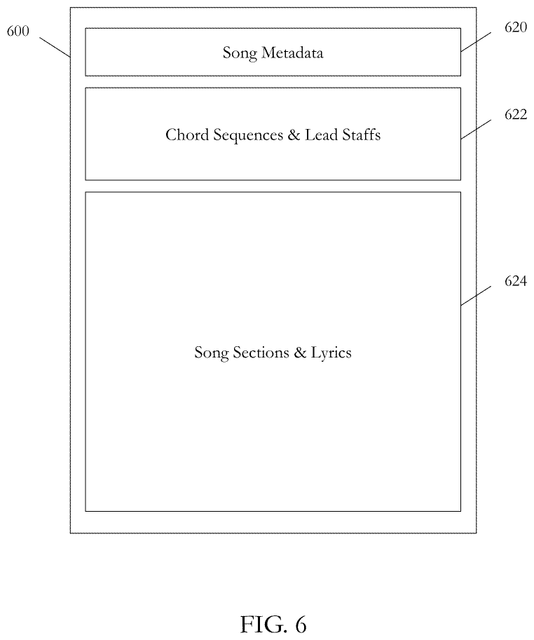

FIG. 6 is a conceptual illustration of a song sheet 600 produced by the system according to an example of the instant disclosure. It shows that the song sheet is generally broken down into three sections for song metadata 620, song harmony as described by chord sequences and/or short lead staffs 622, and song structure and lyrics 624. Other examples may vary slightly in both the general layout of song sheets, and the arrangement and presentation of their elements.

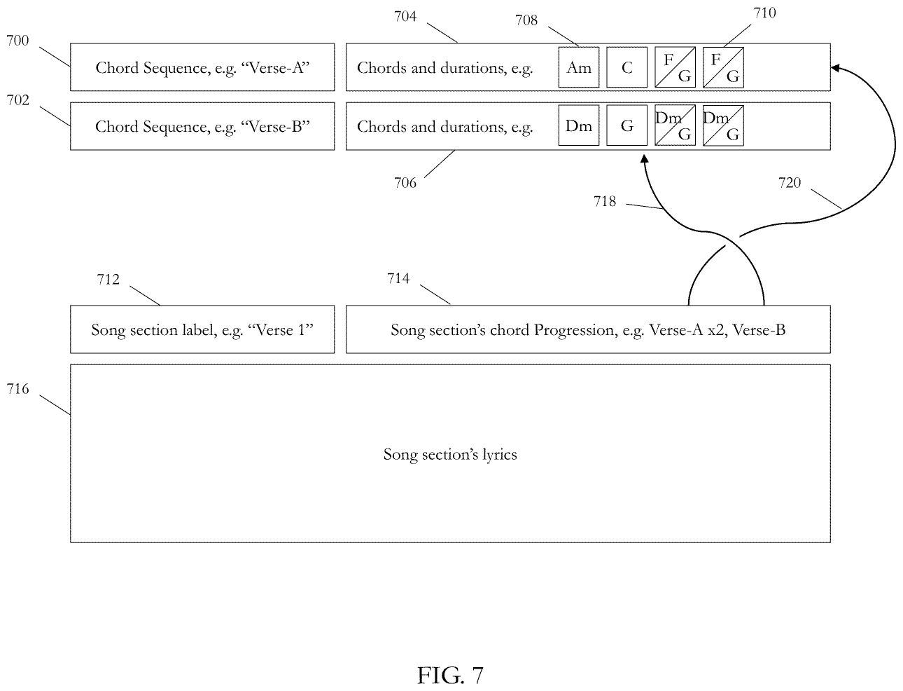

FIG. 7 shows in further detail how the elements of a song sheet produced may be represented, and how they relate to one another according to an example of the instant disclosure. Specifically, FIG. 7 shows a possible way of representing song harmony with two chord sequences, with labels 700, 702 to the left of the song sheet, and the definition of these sequences 704, 706 adjacent to each label. In this particular example, the chord sequences are represented as chord grids. The grids may include squares that each represent one measure of music, and inside the squares are chord names, such as A minor 708. The squares may be further divided into halves or quarters to indicate chord changes that take place within a given measure. For instance, square 710 is divided into two half-measures that play an F major and G major chords, respectively.

Even further, as an illustrative example, FIG. 7 shows a possible layout for a single song section as part of a song sheet produced by the system. It may include a section label 712, a chord progression 714, and lyrics 716. For illustrative purposes, the chord progression repeats the “Verse A” chord sequence twice, followed by a single instance of the “Verse B” chord sequence. There may be referencing of chord sequences declared in the harmony section of the song sheet by individual song section using labels. The referencing is by arrows 718 and 720, which shows that the labels in chord progression 714 point to the chord sequence definitions 706 and 704, respectively.

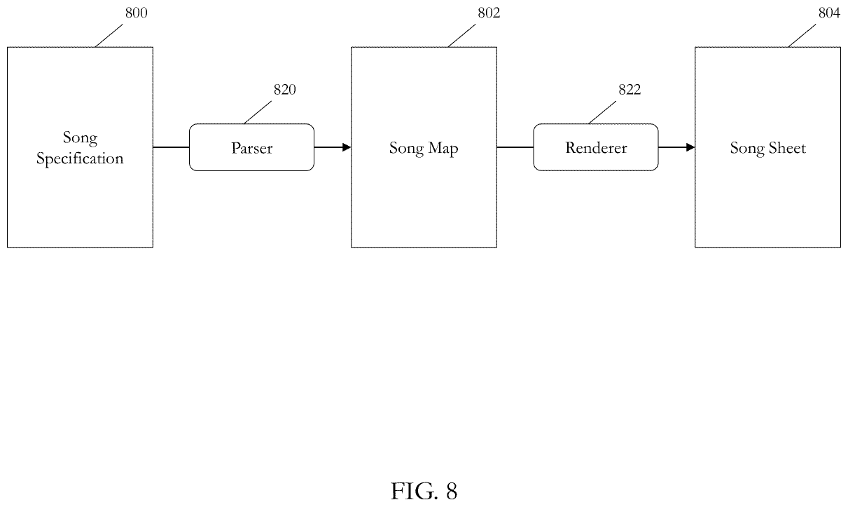

FIG. 8 shows the process of transforming a text-based song specification 800 into an abstract representation of the song as a data structure, or song map 802, and on to a formatted song sheet 804.

As an example, the parser 820 breaks down a string of textual information into meaningful parts by recognizing certain symbols and their arrangement. For instance, in one example, a song's chord sequence may be specified by starting a new line with the “#” character. As a result, the parser program will interpret the other characters on that line of text as a chord sequence. Depending on the syntax used, a semi-colon may be used to separate the chord sequence's label from its musical content. The parser program is responsible for sorting out this information. The parser produces a tree, which is a data structure that holds sequential, nested information. The information may be a list of chord sequences defined by their labels, each of which is mapped to the chords in the sequence. The generated result is a song map 802, which is a data structure that represents all the information comprising the song in a format that more efficiently stores the information in one of memory or disk space to improve on conventional solutions.

The renderer 822 turns the song map into a human readable, visually pleasing document, which is the song sheet used by musicians. In one example, the renderer 822 may convert the song map held in a computer's memory into a format that can be interpreted by TeX, a typesetting software system widely used to produce printable documents. In another example, the renderer may convert the song map into HTML code that can be interpreted by an internet browser to produce a formatted GUI on a display, which in turn can be directly output or exported to a .PDF file for storage and printing.

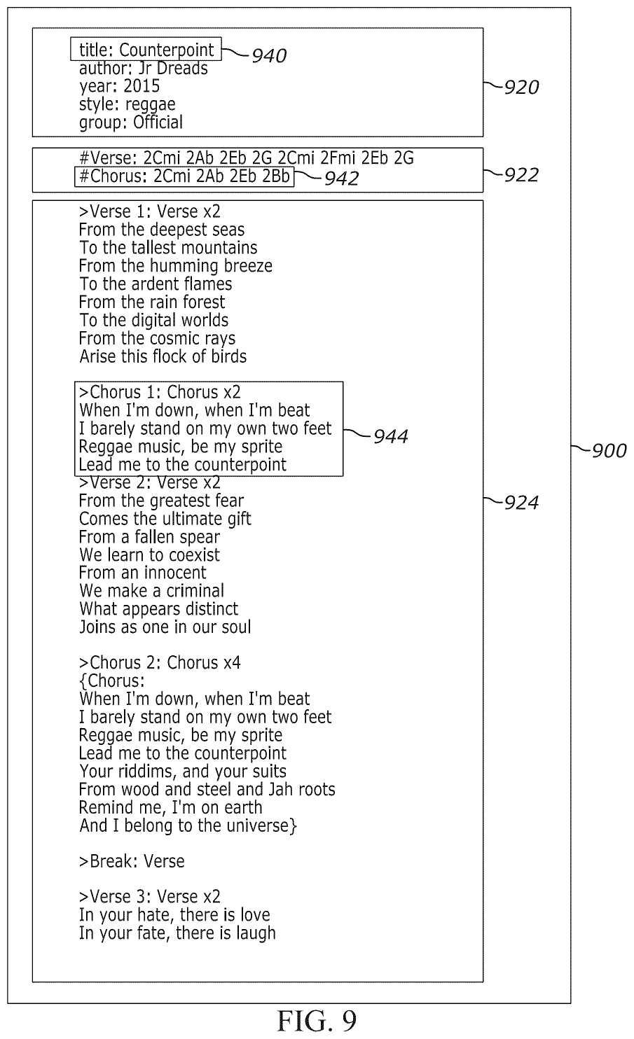

FIG. 9 exhibits an illustrated example of a song specification 900 according to an example of the instant disclosure. In this example, three main sections can be distinguished: the song metadata 920, the song's chord sequences 922, and the song's sections 924, including their labels, chord progressions and lyrics. In further details, the metadata is specified as a set of line-separated key-value pairs. For instance, the song's title is specified by starting a new line with the word “title”, followed by a semi-colon, followed by the title of the song 940. A chord sequence 942 is specified by starting a new line with a “#” character, followed by the sequence's label “Chorus”, followed by a sequence of chords and their duration. A song section 944 is specified by starting a new line with a “>” character, followed by the section's label “Chorus 1”, followed by a semi-colon, followed by references to chord sequence labels and the number of times they are each repeated, followed by a new line and a paragraph of lyrics.

FIG. 9 represents one example. For instance, the characters used to signal chord grid and song section specifications are arbitrary and using a different set of characters for a similar purposes, or a different layout, merely constitute different embodiments of the method.

In another example, the system may provide interactive, incremental inputs with realtime rendering.

In one example, users may submit their song specifications in an interactive and incremental fashion and visualize the formatted output in realtime. In this scenario, the graphical user interface may include two panels. One panel is a text input panel in which the user can type or insert a song specification. The other panel may display the rendering output in SVG format or another format. Every modification in the text input panel is immediately reflected in the rendering panel. This provides the user with an interactive experience, which not only provides instant results, but also makes it easier and more intuitive for a user to learn the song specification syntax. In this example, the parsing, mapping and generating steps are implemented in near real-time by embedding them in a web browser or other format using JavaScript or another way.

In another example, the system may provide rhythm anchors.

Song specifications and the corresponding song sheets generated by the method and system may also feature rhythm anchors. In the song sheet, rhythm anchors can be shown as marks or indications in the left margin adjacent to the lyrics. Each lyric line or stanza may receive a single rhythm anchor. The anchor can indicate a beat number and beat subdivision that allows the singer to properly time the lyrics against the music. By default, the rhythm anchor marks the timing of the first syllable of the lyric line to which it is assigned. However, the song specification also allows the anchor to be defined with respect to an arbitrary syllable in the line. In both cases, the user of the system specifies the beat number and beat subdivision of an anchor using a textual representation in the song specification. This anchor specification is placed directly in the lyrics, either at the start of a line, or tied to a particular fragment that corresponds to a single syllable. The specification is then carried into the song map, and eventually rendered into the graphical user interface and the formatted song sheet. In the song sheet, the syllable of lyrics that is tied to the rhythm anchor can be indicated by a light rectangle frame surrounding it, or if the rhythm anchor is tied to the first syllable of the line, no framing may be used.

In another example, the system may provide a DAW interface.

Song specifications may be exported to a digital audio workstation (DAW) used by musicians, songwriters and music producers to record, edit, arrange, mix, and master audio files of song recordings. Many DAWs feature an arrangement track, which shows the sequence of song sections (e.g. “Verse 1”, “Chorus 1”, etc.) against a timeline view. The naming and duration of each section is part of the system and method's song specification, and can therefore be input to a DAW, saving several minutes of work manually entering this information.

In another example, the system may provide artificial intelligence (AI) input and playback.

The system and method can provide formal semantics to specify the structure of songs, including the song sections, lyrics, chord sequences and rhythm anchors. An artificial intelligence (AI) model may be trained to create a song specification from an audio recording, which can improve the process of obtaining a formatted song sheet for the song. In one example, the model may be initially trained with a library of audio recordings and corresponding song specifications.

By the same token, the artificial intelligence model may be trained and used to follow along an extant specification during audio playback of a particular song and highlight the current position of playback on the song sheet in a graphical user interface. This feature may assist musicians and singers during performance by calling their attention to the exact location on the graphical user interface that they need in the present moment.

### Example Use Case

Consider a song specification for a popular song, where the metadata includes the title “Example Song,” key signature “C Major,” tempo “120 BPM,” and time signature “4/4.” The chord sequences might define a “Verse-A” sequence as [C, G, Am, F] and a “Chorus” sequence as [F, G, C, C]. The song sections are labeled as “Verse 1,” “Chorus,” “Verse 2,” and “Outro,” each with corresponding lyrics.

The system may receive this song specification, parse the input to identify the elements, map the sections to their chord sequences and lyrics, and generate a song map to provide a graphical user interface output that may be used to generate a formatted song sheet that can display these elements in a compact layout on a single page.

### Alternative Embodiments

Alternative embodiments may include variations in the input format, such as allowing for visual or audio input. The rendering module could support additional formats, such as LaTeX for advanced typographic control. The system could also include mobile applications or integrations with digital audio workstations (DAWs) to enhance the usability and versatility of the song sheet generation process.

### Advantages of the System

The present system provides several advantages over traditional song sheet formats:

Compact and Legible: The formatted song sheet is optimized for single-page display, minimizing page-turning or interacting with touch interfaces on displays during performances.

Versatile: Supports various input and output formats, enabling easy integration into different digital workflows.

Customizable: Users can adjust the layout and presentation to fit their needs, enhancing usability.

Enhanced Usability for Bands: The system's structure, which maps sections to chord progressions, is particularly useful for band performances, where multiple musicians synchronize their parts.

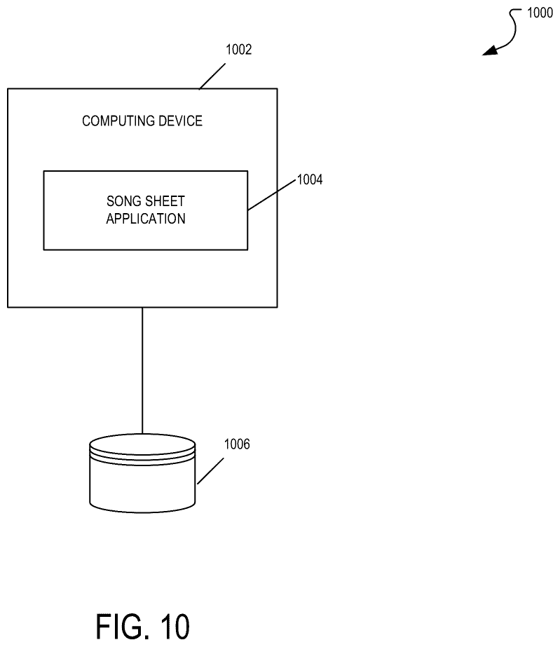

FIG. 10 illustrates a block diagram of a song sheet specification, formatting, and generation system 1000 according to an example embodiment. The song sheet specification, formatting, and generation system 1000 may include a plurality of computing devices including at least one computing device 1002 that may communicate via a communication network. The at least one computing device 1002 may be one or more computing devices, a virtual machine, a container, or another computing virtualization that may be capable of executing one or more programs or applications. The at least one computing device 1002 may execute and deploy a song sheet application 1004.

The at least one computing device 1002 is configured to receive data from and/or transmit data to other computing devices through the communication network. Although the at least one computing device 1002 is shown as a single computing device, it is contemplated that the at least one computing device 1002 may include multiple computing devices.

The communication network can be the Internet, an intranet, or another wired or wireless communication network. For example, the communication network may include a Mobile Communications (GSM) network, a code division multiple access (CDMA) network, 3^{rd} Generation Partnership Project (GPP) network, an Internet Protocol (IP) network, a wireless application protocol (WAP) network, a WiFi network, a Bluetooth network, a satellite communications network, or an IEEE 802.11 standards network, as well as various communications thereof. Other conventional and/or later developed wired and wireless networks may also be used.

The at least one computing device 1002 includes at least one processor to process data and memory to store data. The processor processes communications, builds communications, retrieves data from memory, and stores data to memory. The processor and the memory are hardware. The memory may include volatile and/or non-volatile memory, e.g., a computer-readable storage medium such as a cache, random access memory (RAM), read only memory (ROM), flash memory, or other memory to store data and/or computer-readable executable instructions such as a portion or component of the song sheet application 1004. In addition, the at least one computing device 1002 further includes at least one communications interface to transmit and receive communications, messages, and/or signals.

The at least one computing device 1002 can be a laptop computer, a smartphone, a personal digital assistant, a tablet computer, a standard personal computer, or another processing device. The at least one computing device 1002 may include a display, such as a computer monitor, for displaying data and/or graphical user interfaces. The at least one computing device 1002 may also include a Global Positioning System (GPS) hardware device or other location systems (e.g., other satellite systems or WiFi triangulation) for determining a particular location of the computing device 1002, an input device, such as a camera, a keyboard or a pointing device (e.g., a mouse, trackball, pen, or touch screen) to enter data into or interact with graphical and/or other types of user interfaces. In an exemplary embodiment, the display and the input device may be incorporated together as a touch screen of the smartphone or tablet computer.

The at least one computing device 1002 may display on the display a graphical user interface (or GUI). The graphical user interface may be provided by the song sheet application 1004. The graphical user interface enables a user of the at least one computing device 1002 to interact with the song sheet application 1004.

The song sheet application 1004 may be a component of an application and/or service executable by the at least one computing device 1002. For example, the song sheet application 1004 may be a single unit of deployable executable code or a plurality of units of deployable executable code. According to one aspect, the song sheet application 1004 may include one component that may be a web application, a native application, and/or a mobile application (e.g., an app) downloaded from a digital distribution application platform that allows users to browse and download applications developed with mobile software development kits (SDKs) including the App Store and GOOGLE PLAY®, among others.

The song sheet specification, formatting, and generation system 1000 may also include a relational database management system (RDBMS), a timeseries database system, a blob storage system, or another type of database management system such as a NoSQL database system that stores and communicates data from at least one database 1006. As an example, the at least one database 1006 may store information associated with song maps and song sheets.

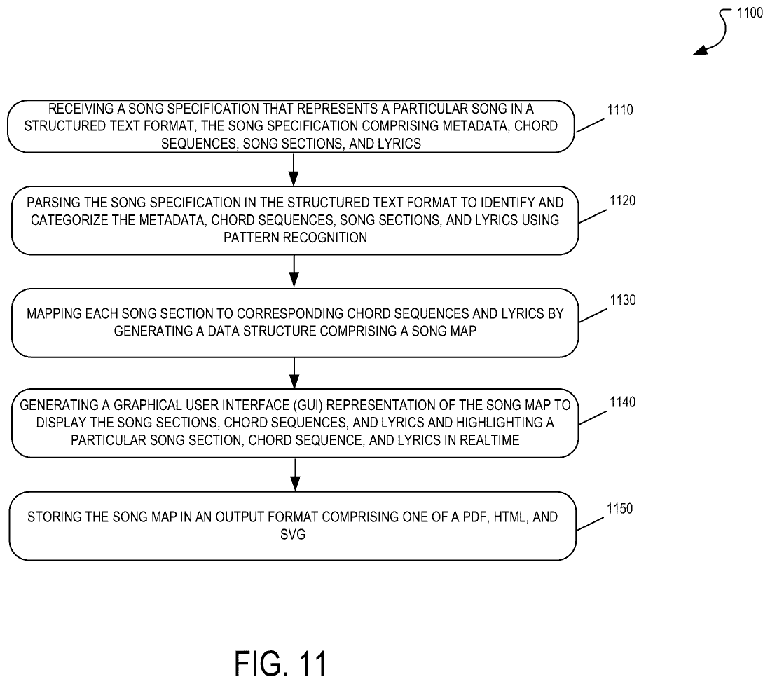

FIG. 11 illustrates an example method 1100 for generating a song map according to an example of the instant disclosure. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

According to some examples, the method 1100 includes receiving, by at least one processor, a song specification that represents a particular song in a structured text format, the song specification comprising metadata, chord sequences, song sections, and lyrics, the structured text format comprising one of a text file, extensible markup language (XML), and Javascript Object Notation (JSON) at block 1110.

In one example, the metadata is specified as a set of line-separated key-value pairs, a chord sequence is specified by a new line with a # character followed by a label, followed by a sequence of chords and an associated duration, and a song section is specified by a new line with a “>” character followed by a label, followed by a semi-colon, followed by references to chord sequence labels and a number of times each is repeated, followed by a new line and a paragraph of lyrics.

According to some examples, the method 1100 includes parsing, by the at least one processor, the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content at block 1120.

According to some examples, the method 1100 includes mapping, by the at least one processor, each song section to corresponding chord sequences and lyrics by generating a data structure comprising a song map at block 1130.

According to some examples, the method 1100 includes generating, by the at least one processor, a graphical user interface (GUI) representation of the song map to display the song sections, chord sequences, and lyrics and highlight a particular song section, chord sequence, and lyrics in realtime during playback of the particular song at block 1140.

According to some examples, the method 1100 includes storing, by the at least one processor, the song map in an output format comprising one of a Portable Document Format (PDF), Hypertext Markup Language (HTML), and Scalable Vector Graphics (SVG) at block 1150.

According to some examples, the method 1100 may include receiving the song specification in a structured text format comprising key-value pairs for metadata, labeled chord sequences, and labeled paragraphs for song sections.

According to some examples, the method 1100 may include validating the song specification to ensure the song specification adheres to a predefined format before parsing.

According to some examples, the method 1100 may include generating at least one rhythm anchor that is displayed in the GUI representation of the song map in a location adjacent to the lyrics that indicates a beat number and a beat subdivision.

According to some examples, the method 1100 may include generating a graphical representation of chord sequences as grids, each grid representing a measure of music.

According to some examples, the method 1100 may include applying formatting rules to ensure that the output format fits on a single page such as an 8.5″ by 11″ page or an A4 page, among others.

According to some examples, the method 1100 may include receiving input from a user to play back individual chord sequences or song sections of the particular song.

According to some examples, the method 1100 may include converting the song map into TeX.

According to some examples, the method 1100 may include transmitting the song map to a digital audio workstation (DAW).

According to further examples, the method 1100 may include exporting the generated song map to cloud storage services.

According to further examples, the method 1100 may include receiving the song specification for processing via a web application programming interface (API).

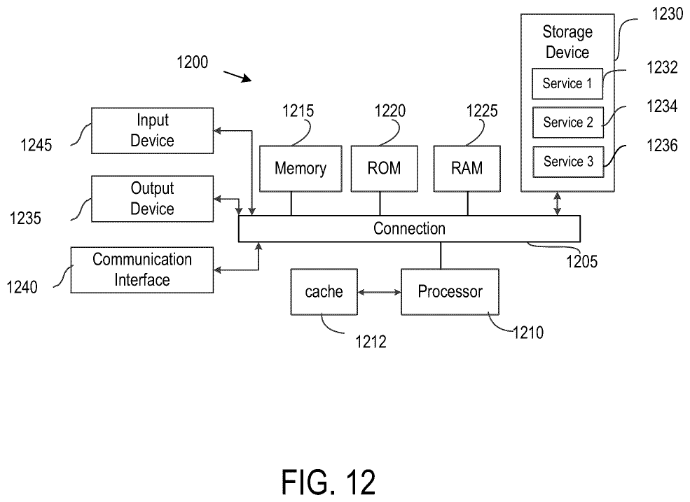

FIG. 12 shows an example of computing system 1200, which can be for example any computing device making up the computing device 1002, or any component thereof in which the components of the system are in communication with each other using connection 1205. Connection 1205 can be a physical connection via a bus, or a direct connection into processor 1210, such as in a chipset architecture. Connection 1205 can also be a virtual connection, networked connection, or logical connection.

In some embodiments, computing system 1200 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 1200 includes at least one processing unit (CPU or processor) 1210 and connection 1205 that couples various system components including system memory 1215, such as read-only memory (ROM) 1220 and random access memory (RAM) 1225 to processor 1210. Computing system 1200 can include a cache of high-speed memory 1212 connected directly with, in close proximity to, or integrated as part of processor 1210.

Processor 1210 can include any general purpose processor and a hardware service or software service, such as services 1232, 1234, and 1236 stored in storage device 1230, configured to control processor 1210 as well as a special-purpose processor where software instructions are incorporated into the actual processor design. Processor 1210 may essentially be a completely self-contained computing system, containing multiple cores or processors, a bus, memory controller, cache, etc. A multi-core processor may be symmetric or asymmetric.

To enable user interaction, computing system 1200 includes an input device 1245, which can represent any number of input mechanisms, such as a microphone for speech, a touch-sensitive screen for gesture or graphical input, keyboard, mouse, motion input, speech, etc. Computing system 1200 can also include output device 1235, which can be one or more of a number of output mechanisms known to those of skill in the art. In some instances, multimodal systems can enable a user to provide multiple types of input/output to communicate with computing system 1200. Computing system 1200 can include communications interface 1240, which can generally govern and manage the user input and system output. There is no restriction on operating on any particular hardware arrangement, and therefore the basic features here may easily be substituted for improved hardware or firmware arrangements as they are developed.

Storage device 1230 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read-only memory (ROM), and/or some combination of these devices.

The storage device 1230 can include software services, servers, services, etc., that when the code that defines such software is executed by the processor 1210, it causes the system to perform a function. In some embodiments, a hardware service that performs a particular function can include the software component stored in a computer-readable medium in connection with the necessary hardware components, such as processor 1210, connection 1205, output device 1235, etc., to carry out the function.

For clarity of explanation, in some instances, the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program or a collection of programs that carry out a specific function. In some embodiments, a service can be considered a server. The memory can be a non-transitory computer-readable medium.

In some embodiments, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer-readable media. Such instructions can comprise, for example, instructions and data which cause or otherwise configure a general purpose computer, special purpose computer, or special purpose processing device to perform a certain function or group of functions. Portions of computer resources used can be accessible over a network. The executable computer instructions may be, for example, binaries, intermediate format instructions such as assembly language, firmware, or source code. Examples of computer-readable media that may be used to store instructions, information used, and/or information created during methods according to described examples include magnetic or optical disks, solid-state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smartphones, small form factor personal computers, personal digital assistants, and so on. The functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Illustrative examples of the disclosure include:

Aspect 1: A method comprising: receiving, by at least one processor, a song specification that represents a particular song in a structured text format, the song specification comprising metadata, chord sequences, song sections, and lyrics, the structured text format comprising one of a text file, extensible markup language (XML), and Javascript Object Notation (JSON), parsing, by the at least one processor, the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, mapping, by the at least one processor, each song section to corresponding chord sequences and lyrics by generating a data structure comprising a song map, generating, by the at least one processor, a graphical user interface (GUI) representation of the song map to display the song sections, chord sequences, and lyrics and highlighting a particular song section, chord sequence, and lyrics in realtime during playback of the particular song, and storing, by the at least one processor, the song map in an output format comprising one of a Portable Document Format (PDF), Hypertext Markup Language (HTML), and Scalable Vector Graphics (SVG).

Aspect 2: The method of Aspect 1, further comprising receiving the song specification in a structured text format comprising key-value pairs for metadata, labeled chord sequences, and labeled paragraphs for song sections and validating the song specification to ensure the song specification adheres to a predefined format before parsing.

Aspect 3: The method of Aspects 1 and 2, further comprising generating at least one rhythm anchor that is displayed in the GUI representation of the song map in a location adjacent to the lyrics that indicates a beat number and a beat subdivision.

Aspect 4: The method of any of Aspects 1 to 3, further comprising generating a graphical representation of chord sequences as grids, each grid representing a measure of music.

Aspect 5: The method of any of Aspects 1 to 4, further comprising applying formatting rules to ensure that the output format fits on a single page.

Aspect 6: The method of any of Aspects 1 to 5, further comprising receiving input from a user to play back individual chord sequences or song sections of the particular song.

Aspect 7: The method of any of Aspects 1 to 6, wherein the metadata is specified as a set of line-separated key-value pairs, a chord sequence is specified by a new line with a # character followed by a label, followed by a sequence of chords and an associated duration, and a song section is specified by a new line with a “>” character followed by a label, followed by a semi-colon, followed by references to chord sequence labels and a number of times each is repeated, followed by a new line and a paragraph of lyrics.

Aspect 8: The method of any of Aspects 1 to 7, further comprising converting the song map into TeX.

Aspect 9: The method of any of Aspects 1 to 8, further comprising transmitting the song map to a digital audio workstation (DAW).

Aspect 10: The method of any of Aspects 1 to 9, further comprising receiving the song specification for processing via a web application programming interface (API).

Aspect 11: A system comprising a non-transitory computer-readable storage medium having instructions and at least one processor to execute the instructions to receive a song specification that represents a particular song in a structured text format, the song specification comprising metadata, chord sequences, song sections, and lyrics, the structured text format comprising one of a text file, extensible markup language (XML), and Javascript Object Notation (JSON), parse the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, map each song section to corresponding chord sequences and lyrics by generating a data structure comprising a song map, generate a graphical user interface (GUI) representation of the song map to display the song sections, chord sequences, and lyrics and highlight a particular song section, chord sequence, and lyrics in realtime during playback of the particular song, and store the song map in an output format comprising one of a Portable Document Format (PDF), Hypertext Markup Language (HTML), and Scalable Vector Graphics (SVG).

Aspect 12: The system of Aspect 11, the at least one processor further to execute the instructions to receive the song specification in a structured text format comprising key-value pairs for metadata, labeled chord sequences, and labeled paragraphs for song sections and validate the song specification to ensure the song specification adheres to a predefined format before parsing.

Aspect 13: The system of Aspect 11 and 12, the at least one processor further to execute the instructions to generate at least one rhythm anchor that is displayed in the GUI representation of the song map in a location adjacent to the lyrics that indicates a beat number and a beat subdivision.

Aspect 14: The system of any of Aspects 11 to 13, the at least one processor further to execute the instructions to generate a graphical representation of chord sequences as grids, each grid representing a measure of music.

Aspect 15: The system of any of Aspects 11 to 14, the at least one processor further to execute the instructions to apply formatting rules to ensure that the output format fits on a single page.

Aspect 16: The system of any of Aspects 11 to 15, the at least one processor further to execute the instructions to receive input from a user to play back individual chord sequences or song sections of the particular song.

Aspect 17: The system of any of Aspects 11 to 16, wherein the metadata is specified as a set of line-separated key-value pairs, a chord sequence is specified by a new line with a # character followed by a label, followed by a sequence of chords and an associated duration, and a song section is specified by a new line with a “>” character followed by a label, followed by a semi-colon, followed by references to chord sequence labels and a number of times each is repeated, followed by a new line and a paragraph of lyrics.

Aspect 18: The system of any of Aspects 11 to 17, the at least one processor further to execute the instructions to convert the song map into TeX.

Aspect 19: The system of any of Aspects 11 to 18, the at least one processor further to execute the instructions to transmit the song map to a digital audio workstation (DAW).

Aspect 20: The system of any of Aspects 11 to 19, the at least one processor further to execute the instructions to receive the song specification for processing via a web application programming interface (API).

Aspect 21: A non-transitory computer-readable storage medium, having instructions stored thereon that, when executed by at least one computing device cause the at least one computing device to perform operations, the operations comprising receiving a song specification that represents a particular song in a structured text format, the song specification comprising metadata, chord sequences, song sections, and lyrics, the structured text format comprising one of a text file, extensible markup language (XML), and Javascript Object Notation (JSON), parsing the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content, mapping each song section to corresponding chord sequences and lyrics by generating a data structure comprising a song map, generating a graphical user interface (GUI) representation of the song map to display the song sections, chord sequences, and lyrics and highlighting a particular song section, chord sequence, and lyrics in realtime during playback of the particular song, and storing the song map in an output format comprising one of a Portable Document Format (PDF), Hypertext Markup Language (HTML), and Scalable Vector Graphics (SVG).

What is claimed is:

1. A method, comprising:
receiving, by at least one processor, a song specification that represents a particular song in a structured text format, the song specification comprising metadata, chord sequences, song sections, and lyrics, the structured text format comprising one of a text file, extensible markup language (XML), and Javascript Object Notation (JSON);
parsing, by the at least one processor, the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content;
mapping, by the at least one processor, each song section to corresponding chord sequences and lyrics by generating a data structure comprising a song map;
generating, by the at least one processor, a graphical user interface (GUI) representation of the song map to display the song sections, chord sequences, and lyrics and highlighting a particular song section, chord sequence, and lyrics in realtime during playback of the particular song; and
storing, by the at least one processor, the song map in an output format comprising one of a Portable Document Format (PDF), Hypertext Markup Language (HTML), and Scalable Vector Graphics (SVG).

2. The method of claim 1, further comprising receiving the song specification in a structured text format comprising key-value pairs for metadata, labeled chord sequences, and labeled paragraphs for song sections and validating the song specification to ensure the song specification adheres to a predefined format before parsing.

3. The method of claim 1, further comprising generating at least one rhythm anchor that is displayed in the GUI representation of the song map in a location adjacent to the lyrics that indicates a beat number and a beat subdivision.

4. The method of claim 1, further comprising generating a graphical representation of chord sequences as grids, each grid representing a measure of music.

5. The method of claim 1, further comprising applying formatting rules to ensure that the output format fits on a single page.

6. The method of claim 1, further comprising receiving input from a user to play back individual chord sequences or song sections of the particular song.

7. The method of claim 1, wherein the metadata is specified as a set of line-separated key-value pairs, a chord sequence is specified by a new line with a # character followed by a label, followed by a sequence of chords and an associated duration, and a song section is specified by a new line with a “>” character followed by a label, followed by a semi-colon, followed by references to chord sequence labels and a number of times each is repeated, followed by a new line and a paragraph of lyrics.

8. The method of claim 1, further comprising converting the song map into TeX.

9. The method of claim 1, further comprising transmitting the song map to a digital audio workstation (DAW).

10. The method of claim 1, further comprising receiving the song specification for processing via a web application programming interface (API).

11. A system, comprising:
a non-transitory computer-readable storage medium having instructions; and
at least one processor to execute the instructions to:
receive a song specification that represents a particular song in a structured text format, the song specification comprising metadata, chord sequences, song sections, and lyrics, the structured text format comprising one of a text file, extensible markup language (XML), and Javascript Object Notation (JSON);
parse the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content;
map each song section to corresponding chord sequences and lyrics by generating a data structure comprising a song map;
generate a graphical user interface (GUI) representation of the song map to display the song sections, chord sequences, and lyrics and highlight a particular song section, chord sequence, and lyrics in realtime during playback of the particular song; and
store the song map in an output format comprising one of a Portable Document Format (PDF), Hypertext Markup Language (HTML), and Scalable Vector Graphics (SVG).

12. The system of claim 11, the at least one processor further to execute the instructions to receive the song specification in a structured text format comprising key-value pairs for metadata, labeled chord sequences, and labeled paragraphs for song sections and validate the song specification to ensure the song specification adheres to a predefined format before parsing.

13. The system of claim 11, the at least one processor further to execute the instructions to generate at least one rhythm anchor that is displayed in the GUI representation of the song map in a location adjacent to the lyrics that indicates a beat number and a beat subdivision.

14. The system of claim 11, the at least one processor further to execute the instructions to generate a graphical representation of chord sequences as grids, each grid representing a measure of music.

15. The system of claim 11, the at least one processor further to execute the instructions to apply formatting rules to ensure that the output format fits on a single page.

16. The system of claim 11, the at least one processor further to execute the instructions to receive input from a user to play back individual chord sequences or song sections of the particular song.

17. The system of claim 11, wherein the metadata is specified as a set of line-separated key-value pairs, a chord sequence is specified by a new line with a # character followed by a label, followed by a sequence of chords and an associated duration, and a song section is specified by a new line with a “>” character followed by a label, followed by a semi-colon, followed by references to chord sequence labels and a number of times each is repeated, followed by a new line and a paragraph of lyrics.

18. The system of claim 11, the at least one processor further to execute the instructions to convert the song map into TeX.

19. The system of claim 11, the at least one processor further to execute the instructions to transmit the song map to a digital audio workstation (DAW).

20. The system of claim 11, the at least one processor further to execute the instructions to receive the song specification for processing via a web application programming interface (API).

21. A non-transitory computer-readable storage medium, having instructions stored thereon that, when executed by at least one computing device cause the at least one computing device to perform operations, the operations comprising:
receiving a song specification that represents a particular song in a structured text format, the song specification comprising metadata, chord sequences, song sections, and lyrics, the structured text format comprising one of a text file, extensible markup language (XML), and Javascript Object Notation (JSON);
parsing the song specification in the structured text format to identify and categorize the metadata, chord sequences, song sections, and lyrics using pattern recognition to determine regular expressions and detect each of the metadata, chord sequences, song sections, and lyrics by locating a specific character that represents each of the metadata and metadata content, a chord sequence and chord sequence content, a song section and song section content, and lyrics and lyrics content;
mapping each song section to corresponding chord sequences and lyrics by generating a data structure comprising a song map;
generating a graphical user interface (GUI) representation of the song map to display the song sections, chord sequences, and lyrics and highlighting a particular song section, chord sequence, and lyrics in realtime during playback of the particular song; and
storing the song map in an output format comprising one of a Portable Document Format (PDF), Hypertext Markup Language (HTML), and Scalable Vector Graphics (SVG).
